(19) United States
(12) Patent Application Publication
(10) Pub. No.: US 2007/0065542 A1
(43) Pub. Date: Mar. 22, 2007

(54) Enhanced solubility of preformed calcium citrate by adding citric acid

(75) Inventor: Charles Y.C. Pak, Dallas, TX (US)

Correspondence Address: CHALKER FLORES, LLP, 2711 LBJ FRWY, Suite 1036, DALLAS, TX, 75234, US

(73) Assignee: Board Of Regents, The University Of Texas System, Austin, TX (US)

(21) Appl. No.: 11/523,938

(22) Filed: Sep. 20, 2006

Related U.S. Application Data
(60) Provisional application No. 60/721,334, filed on Sep. 29, 2005.
(60) Provisional application No. 60/720,774, filed on Sep. 28, 2005.
(60) Provisional application No. 60/721,297, filed on Sep. 20, 2005.

(51) Int. Cl. A23L 1/30

(52) U.S. Cl. 426/74

(57) ABSTRACT

The present invention includes compositions and methods for the preparation and delivery of calcium citrate under physiological conditions by preparing solid preformed calcium citrate, adding citric acid to the calcium citrate, wherein citric acid is added to the calcium citrate in a molar ratio of between 0.1 and 0.6 mol of citric acid per mol of calcium citrate to provide a calcium citrate-citric acid mixture; and forming a tablet from the calcium citrate-citric acid mixture. The compositions and methods were found to increase the solubility of iron and calcium.

### TECHNICAL FIELD OF THE INVENTION

The present invention relates in general to the field of calcium supplementation, and more particularly, to compositions and methods for the increased solubility of dietary calcium.

### BACKGROUND OF THE INVENTION

This application claims priority to U.S. Provisional Patent Application Ser. No. 60/721,297 filed Sep. 20, 2005, United States Provisional Patent Application Serial No. 60/720,774 filed Sep. 28, 2005, and U.S. Provisional Patent Application Ser. No. 60/721,334 filed Sep. 29, 2005 the entire contents of each of which is incorporated herein by reference. Without limiting the scope of the invention, its background is described in connection with dietary calcium supplements.

Oral mineral supplements of calcium have become popular because of the difficulty or reluctance of subjects in meeting these mineral needs by dietary means. To be useful, such oral calcium supplements must first be well tolerated without untoward gastrointestinal side effects. They must also be sufficiently soluble in the fluid of the intestinal lumen so that they can be absorbed. Popular among calcium supplements is tricalcium dicitrate tetrahydrate (henceforth to be called calcium citrate) known for its excellent tolerance. However, calcium citrate is incompletely dissolved in the gastric juice in persons with deficient gastric acid secretion. This invention purports to a method for overcoming this problem, that is, enhance the solubility of preformed calcium citrate in the gastric juice even when there is insufficient acid content, by a process of adding citric acid.

Calcium citrate has been shown to be more soluble and absorbable than two other commonly used calcium salts: calcium carbonate (Heller et al., J Clin Pharm 40: 1237-1244, 2000) and calcium phosphate (Schuette & Knowles, Am J Clin Nutr 47: 884-888, 1988). However, calcium citrate does not fully dissolve in gastric juice that is low normal or low in acid content (Pak et al., J Bone Min Res 4: 119-127, 1989). Some elderly persons and individuals who are taking inhibitors of gastric acid secretion (for example, for esophageal reflux disease) may suffer from insufficient secretion of gastric acid (O'Connell et al., Amer J Med 118: 778-781). In such persons, even the more soluble calcium citrate may not fully dissolve to be absorbed and meet their calcium needs. Thus, there is need to improve the solubility of “preformed” calcium citrate, the term “preformed” intended to mean hereinafter, already formulated solid compound ready for making into an oral tablet formulation.

Prior patents have attempted to modify calcium citrate to make it more soluble and thereby more absorbable. One way was by making a premix that contained different amount of citrate relative to calcium (prior patent of the inventor, U.S. Pat. No. 4,851,221, issued on Jul. 25, 1989). Designed to be dissolved before oral ingestion, the premix comprised a mixture of calcium hydroxide (or calcium carbonate) and citric acid, at the same calcium:molar ratio as tricalcium dicitrate of 1:0.67, or with a slight excess of citrate. When added to water, the mixture rapidly dissolved, creating a “metastably supersaturated” solution of calcium citrate (Pak et al., J Clin Endo Metab 65: 801-805, 1987). Even though supersaturated, the precipitation of calcium citrate could be delayed for several hours leaving enough time for calcium to be absorbed. Unfortunately, the premix has received limited acceptance and was removed from the market in the United States.

In another prior patent of the inventor (U.S. Pat. No. 5,075,499, issued on Dec. 24, 1991), a solid formulation of calcium citrate-lactate at a molar ratio of 2:1:1 was formulated. This “compound” was shown to be much more soluble and absorbable than solid calcium citrate. However, calcium citrate-lactate is difficult to manufacture and has never been marketed. Likewise, calcium citrate-malate was shown to be soluble and absorbable (U.S. Pat. No. 4,722,847, issued on Feb. 2, 1988). This innovation has been used mainly to fortify fruits juices with calcium, and not widely applied in making a tablet formulation.

### SUMMARY OF THE INVENTION

The present invention includes the unique ability of citric acid to increase the solubility of preformed calcium citrate by forming soluble complexes with calcium. The citric acid also increases the acidity of the medium (such as gastric juice), rendering the preformed solid calcium citrate more soluble. The above actions of citric are quantitatively and qualitatively different than those of ascorbic acid, representing one of other common, less preferred, organic acids. This circumstance emphasizes the special embodiment of this invention. The above cited problems are addressed herein by increasing the solubility of calcium under physiological conditions while at the same time decreasing the size of the tablet or pill.

The key aspect of the invention includes a method for making preformed solid calcium citrate supplement in a tablet form more soluble, and therefore more absorbable, by adding citric acid, this action of citric acid being more prominent or preferable than that of other common organic acids (such as ascorbic acid). The increased solubility with an organic acid, e.g., citric acid, is important because oral calcium must be in a soluble form before it can be absorbed. The popular calcium citrate supplement is incompletely dissolved and absorbed in persons with low normal or insufficient gastric acid secretion. This invention reveals that addition of citric acid dramatically increases the solubility of preformed calcium citrate even when the acid content is low.

The solubility of many calcium salts is dependent on acidity, with more calcium dissolved with increasing acidity of the medium. Since the dissolved calcium is composed of ionized calcium and complexed calcium, the solubility of many calcium salts is also influenced by the formation of soluble complexes of calcium with accompanying anions (negatively charged substances). Thus, a calcium salt can be rendered more soluble by increasing acidity or complexing more calcium.

It was found that citric acid increases the solubility of preformed calcium citrate by dual mechanisms: increasing acidity as well as accentuating the formation of soluble calcium citrate complexes. As representative of other less preferred organic acids, ascorbic acid also enhances the solubility of preformed calcium citrate, though less effectively than citric acid. The action of ascorbic acid is mediated mainly by increasing the acidity of the medium, not so much by forming a soluble complex.

Besides ascorbic acid, the above function of citric acid may be met by some of the other common organic acids, such as lactic acid, formic acid, acetic acid, gluconic acid, fumaric acid, succinic acid, and malic acid. Lactic acid, formic acid and acetic acid are generally found as liquids, not generally suitable in making a solid tablet formulation, therefore these may find particular uses in gelcaps and other liquid or semi-liquid formulations. Gluconic acid, fumaric acid, succinic acid, and malic acid have some chelating properties, but their propensity to form a soluble complex with calcium is less prominent than that of citric acid, as shown herein. Among other organic acids, only ascorbic acid is directly compared with citric acid. Ascorbic acid was found to be representative of the action of other organic acids. The foregoing discussion emphasizes the uniqueness of the embodiment of this invention involving the use of citric acid to enhance the solubility of preformed calcium citrate.

The increased amount of soluble calcium accomplished by the process of this invention should also lead to improved calcium absorption. As described heretofore, dissolved calcium (from the reaction of calcium citrate with citric acid) is composed of ionized calcium and soluble calcium citrate complexes. Ionized calcium is absorbed from the bowel by active transport (requiring energy). Calcium citrate complex has been shown to be absorbed passively (without expenditure of energy) by a paracellular pathway (passage between cells)(Favus & Pak, Am J Therap 8: 425-431, 2001). This mechanism was invoked to explain superior bioavailability of calcium citrate compared with calcium carbonate (Heller et al., J Clin Pharm Therap 40: 1237-1244, 2000). In persons with impaired active transport of calcium due to vitamin D deficiency or estrogen lack, the passive absorption of calcium citrate complexes may take over to meet calcium needs (Heller et al., J Clin Pharm 42: 1251-1256, 2002). In support of the passive means for absorbing calcium, aluminum citrate complex has also been shown to be absorbed passively (Slanina et al., Clin Chem 32: 339-341, 1986). This mechanism has been invoked to explain aluminum toxicity that develops in patients with kidney failure taking aluminum antacids with citrus juices.

In certain embodiments, the present invention includes a formulation and a method of reducing size of a calcium-citrate-containing tablet without reducing calcium bioavailability under physiological conditions, by preparing solid preformed calcium citrate; adding citric acid to the calcium citrate, wherein citric acid is added to the calcium citrate in a molar ratio of between 0.1 and 0.6 mol of citric acid per mol of calcium citrate to provide a calcium citrate-citric acid mixture; and forming a tablet from the calcium citrate-citric acid mixture, whereby when consumed by a human, the added citric acid not only maintains more calcium in soluble form under slightly acidic physiologic conditions, but also improves the solubility of calcium citrate in the digestive systems of humans with low normal or low acid content, and whereby adding a limited amount of citric acid provides the same or enhanced bioavailability of calcium from a tablet of reduced size or an even greater bioavailability of calcium with only a relative small increase in tablet size.

The present invention includes compositions and methods for enhancing calcium bioavailability of a calcium citrate-containing tablet by a proportionately greater amount relative to change in weight under physiological conditions, by preparing solid preformed calcium citrate, adding citric acid to the calcium citrate, wherein citric acid is added to the calcium citrate in a molar ratio of between 0.1 and 0.6 mol of citric acid per mol of calcium citrate to provide a calcium citrate-citric acid mixture and forming a tablet from the calcium citrate-citric acid mixture. In one example, the molar ratio between citric acid per mol of calcium citrate is between 0.133 and 0.3, and alternatively, may further include carbonyl iron. Using the present invention a tablet or other formulation may be made that delivers from calcium citrate from about 50 to 350 mg calcium per tablet. As the skilled artisan will recognize, the tablet may be compressed or made into a gelcap, effervescent capsule, a mini-tab, a combination tablet with an immediate and a sustained release component and the like. In another example, the amount of calcium citrate is 200-315 mg calcium per tablet. Citric acid for use with the present invention may be anhydrous, a monohydrate or combinations thereof.

The present invention may be formulated into a tablet that may also have an enteric coating or may be a dual-layer tablet comprising an immediate release and a sustained release portion. In one embodiment, the tablet may deliver 50-350 mg calcium as preformed calcium citrate tablet with less than 80% the tablet volume of a non-citric acid containing tablet. The tablet may be compressed to a bulk density of between 0.9 g/cc and 1.3 g/cc and may alternatively include one or more vitamins selected from the group consisting of vitamin A, vitamin B1, vitamin B2, vitamin B6, vitamin B12, vitamin C, vitamin D, vitamin E, folic acid, iodine, copper, zinc, niacinamide, and any combination thereof.

The present invention also includes a method of controlling tablet size of a calcium citrate-containing tablet for human consumption, while enhancing bioavailability of calcium when in the human digestive system, by preparing solid preformed calcium citrate, adding citric acid to the calcium citrate, wherein citric acid is added to the calcium citrate in a molar ratio of between 0.1 and 0.6 mol of citric acid per mol of calcium citrate to provide a calcium citrate-citric acid mixture and forming a tablet from the calcium citrate-citric acid mixture. Another method of making a calcium citrate-and-iron containing tablet for human consumption, with enhanced bioavailability of calcium and iron when in the human digestive system includes preparing a blend of calcium citrate and carbonyl iron, wherein the molar ratio of carbonyl iron to calcium citrate is between 0.04 and 1.5; adding citric acid to the calcium citrate, wherein citric acid is added in total of a molar ratio of between 0.1 and 0.6 mol of citric acid per mol of calcium citrate plus a molar ratio of between 0.1 and 3.0 mol of citric acid per mol of carbonyl iron to provide a calcium citrate-carbonyl iron-citric acid combination; and forming a tablet from the calcium citrate-carbonyl iron-citric acid combination, whereby when consumed by a human, solubility of iron and calcium citrate are enhanced. One example of the molar ratio of citric acid per mol of carbonyl iron is at or between 0.62 and 1.23, or even a molar ratio of carbonyl iron to calcium citrate is 0.32.

Yet another embodiment of the present invention is a method of making an iron-containing tablet for human consumption, with enhanced bioavailability of calcium and iron when in the human digestive system by preparing a predetermined amount of carbonyl iron, adding citric acid to the carbonyl iron, wherein citric acid is added in a molar ratio of between 0.1 and 3 mol of citric acid per mol of carbonyl iron to provide a carbonyl iron-citric acid combination; and forming a tablet from the carbonyl iron-citric acid combination, whereby when consumed by a human, solubility of iron is enhanced.

When preparing a tablet, this may be made by a method that includes preparing solid preformed calcium citrate, adding citric acid to the calcium citrate, wherein citric acid is added to the calcium citrate in a molar ratio of between 0.1 and 0.6 mol of citric acid per mol of calcium citrate to provide a calcium citrate-citric acid mixture and forming a tablet from the calcium citrate-citric acid mixture. The tablet or other formulation, e.g., an enveloped formulation (e.g., a capsule) may be used, e.g., in a method of treating a vitamin or mineral deficiency of a human, by administering to the human a formulation that includes a solid preformed source of calcium citrate; and an organic acid in a molar ratio of between 0.1 and 0.6 mol of citric acid per mol of calcium citrate to provide a calcium citrate-citric acid mixture. Examples of organic acids include citric acid, lactic acid, fumaric acid, succinic acid, malic acid, ascorbic acid and combinations thereof. The calcium citrate for use in the formulation may be, e.g., ultradense calcium citrate, calcium lactate, calcium fumarate, calcium succinate, calcium malate, calcium ascorbate, calcium acetate or calcium gluconate, calcium citrate-lactate, calcium citrate-malate, and combinations thereof. The calcium citrate may provide, e.g., 50-350 mg (1.25-8.75 mmol) calcium per tablet. One example of a molar ratio of citric acid to calcium citrate is between 0.1 and 0.6 mol of citric acid per mol of calcium citrate, and may also include a source of iron. Examples of mammals that will benefit from the present invention include, e.g., those that are pregnant, postmenopausal women with borderline iron deficiency, osteoporosis, osteomalacia/rickets, low blood calcium, achlorhydria or an induced deficiency in gastric acid production. The amount of iron per dose ranges from 0.2 mmol to 3 mmol (11-168 mg) and that of citric acid from 0.5 mmol to 4 mmol (94-756 mg) and the source of iron may be a carbonyl iron, an insoluble iron (reduced iron, iron oxide, iron carbonate or iron succinate), a soluble iron (iron lactate, iron fumarate, iron malate, iron ascorbate, or iron gluconate) and combinations thereof.

The present invention also includes a method of reducing size of a calcium-citrate-containing tablet for human consumption, without reducing bioavailability of calcium from the tablet when in the human digestive system, by preparing a formulation that includes a solid preformed calcium citrate, adding citric acid to said calcium citrate, wherein citric acid is added to said calcium citrate in a ratio of between 1.33 and 2 mmol of citric acid per 10 mmol of calcium as preformed calcium citrate to provide a calcium citrate-citric acid mixture and forming a tablet from said calcium citrate-citric acid mixture, whereby when consumed by a human, the added citric acid not only maintains more calcium in soluble form, especially in portions of the human digestive system that are slightly acidic, but also improves the solubility of calcium citrate in digestive systems of humans with low normal or low acid content, and whereby adding a limited amount of citric acid provides significantly enhanced bioavailability of calcium in the human digestive system can be attained for a given tablet size or an even greater bioavailability of calcium with only a relative small increase in tablet size.

Yet another invention includes a method of enhancing calcium bioavailability of a calcium citrate-containing tablet by a proportionately greater amount relative to change in weight under physiological conditions, by preparing solid preformed calcium citrate, adding citric acid to the calcium citrate, wherein citric acid is added to the calcium citrate in a molar ratio of between 1.33 and 3 mol of citric acid per 10 mol of calcium citrate to provide a calcium citrate-citric acid mixture; and forming a tablet from the calcium citrate-citric acid mixture.

### BRIEF DESCRIPTION OF THE DRAWINGS

For a more complete understanding of the features and advantages of the present invention, reference is now made to the detailed description of the invention along with the accompanying figures and in which:

FIG. 1 graphically illustrates the solubility curve of calcium citrate in solutions of varying hydrochloric acid content (mimicking different degrees of gastric acid secretion), by displaying the amount of total dissolved calcium, ionized calcium and complexed calcium at various pHs.

FIG. 2 graphically illustrates the ability of different amounts of citric acid to increase the solubility of preformed calcium citrate in artificial solutions mimicking varying degrees of gastric acid secretion.

FIG. 3 graphically illustrates that the pH decreases (top of figure) but the amount of complexed calcium increases (bottom of figure), when increasing amounts of citric acid are added.

FIG. 4 graphically illustrates that addition of 4.5 mmol of ascorbic acid enhances the solubility of preformed calcium citrate in solutions containing varying amounts of hydrochloric acid, but to a lesser extent than 3 mmol of citric acid (shown by dashed line in the Figure).

FIG. 5A and 5B graphically illustrates that added ascorbic acid decreases pH (5A) but only slightly affects the amount of complexed calcium (5B).

FIG. 6 graphically illustrates that the amount of soluble iron in simulated gastric juices of varying acidity is much higher when carbonyl iron (along with ascorbic acid) is incubated with calcium citrate, as opposed to calcium carbonate, at a corresponding content of hydrochloric acid (HCl).

FIG. 7 graphically reveals that the amount of dissolved calcium is much higher in the presence of calcium citrate than calcium carbonate at a corresponding content of hydrochloric acid.

FIG. 8 graphically illustrates that the amount of dissolved iron increases as the pH of the medium decreases (becomes more acid), and that the curve for calcium citrate is essentially the same as that of calcium carbonate though somewhat shifted to the left.

FIG. 9 graphically illustrates that the pH of medium is much lower (more acid) in the presence of calcium citrate than calcium carbonate, at a corresponding hydrochloric acid content in solution.

FIG. 10 graphically illustrates that the amount of dissolved calcium drops abruptly at pH of little over 4 in the presence of calcium citrate, and pH of just over 6 in the presence of calcium carbonate.

FIG. 11 graphically illustrates that the amount of soluble, complexed iron (after incubation of carbonyl iron with calcium citrate or calcium carbonate) is small and remains low despite increased content of hydrochloric acid.

FIG. 12 graphically depicts the ability of citric acid (1 mmol and 2 mmol) in simulated low basal acid secretion (0.72 mmol hydrochloric acid per 250 ml) to enhance the solubility of carbonyl iron in the presence of ascorbic acid, revealing that much of the dissolved iron is free ion (shown by open area), not complexed iron (depicted by shared area).

FIG. 13 graphically illustrates the ability of added citric acid to reduce pH (making solution more acid).

FIG. 14 graphically shows that after iron is dissolved in acid medium (10 mmol hydrochloric acid per 250 ml), the amount of dissolved iron is still substantial when the medium is neutralized by 10 mmol of sodium bicarbonate (mimicking pancreatic secretion), partly due to the formation of soluble iron complexes (shown by shaded area).

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Additional features and advantages of the invention will be described hereinafter which form the subject of the claims of the invention. It should be appreciated by those skilled in the art that the conception and specific embodiment disclosed may be used readily as a basis for modifying or designing other structures for carrying out the same purposes of the present invention. The skilled artisan will also recognize that equivalent formulations and methods of packaging do not depart from the spirit and scope of the invention as set forth in the appended claims. For example, other organic acids that can be used with or instead of citric acid, e.g., lactic acid, formic acid, acetic acid, gluconic acid, fumaric acid, succinic acid, malic acid and ascorbic acid. However, they are expected to be less effective or preferred than citric acid.

The underlying premise, but not a limitation of the present invention, is that additional citric acid can substantially increase the solubility of preformed calcium citrate, by two mechanisms, acidifying the medium and forming soluble complexes with calcium. Only one of the mechanisms is shared by ascorbic acid, another organic acid that is inferior to citric acid in enhancing the solubility of preformed calcium citrate. Ascorbic acid is tested here as being representative of other common organic acids, which may have some effect in solubilizing calcium citrate but which are not as effective or in some specific cases as citric acid.

### EXAMPLE 1

Construction of the solubility curve of preformed calcium citrate alone: calculation of total, ionized and complexed calcium. Prior studies have shown that the solubility of calcium citrate in aqueous medium is dependent on pH (Pak et al., J Bone Miner Res 4: 119-127, 1989). Calcium citrate is partially dissolved in water and weak acid solutions, but reaches full dissolution in stronger acid solutions. Citrate is a strong chelator of calcium. In the presence of citrate, the total dissolved calcium is composed of ionized calcium and complexed calcium. In this Study, the solubility curve was constructed separately for total calcium, ionized calcium and complexed calcium.

Methods. The solubility of solid calcium citrate containing 400 mg (10 mmol) calcium (a typical single dose) was determined in artificial solutions containing varying amounts of hydrochloric acid using the same in vitro model (Pak et al., J Bone Min Res 4: 119-127, 1989). In 250 ml of deionized water containing varying amounts of hydrochloric acid (0, 0.5, 0.72, 1.0, 2.4, 4.0, 6.0, 7.26, 10.0, 15.0 and 24.6 mEq), 400 mg of calcium as preformed calcium citrate were added. After 1 hour of incubation at 37° C., filtrates were obtained by passing through 0.22 micron filter, and analyzed for pH, calcium, chloride and citrate.

The analyzed calcium in the filtrate represented total calcium, comprised of ionized and complex calcium. The amount of ionized and complexed calcium was calculated by the computer program Equil 2 (Werness et al., J Urol 134:1242-1244, 1985). Entered into the computer program were measurements in filtrates from this model system: pH, calcium, chloride, citrate and total volume. Inserted into the software were stability constants for calcium citrate complex (CaCit¹⁻), calcium monohydrogen citrate complex (CaHCit) and calcium dihydrogen citrate complex (CaH₂Cit¹⁺) to be described in detail in the next Example.

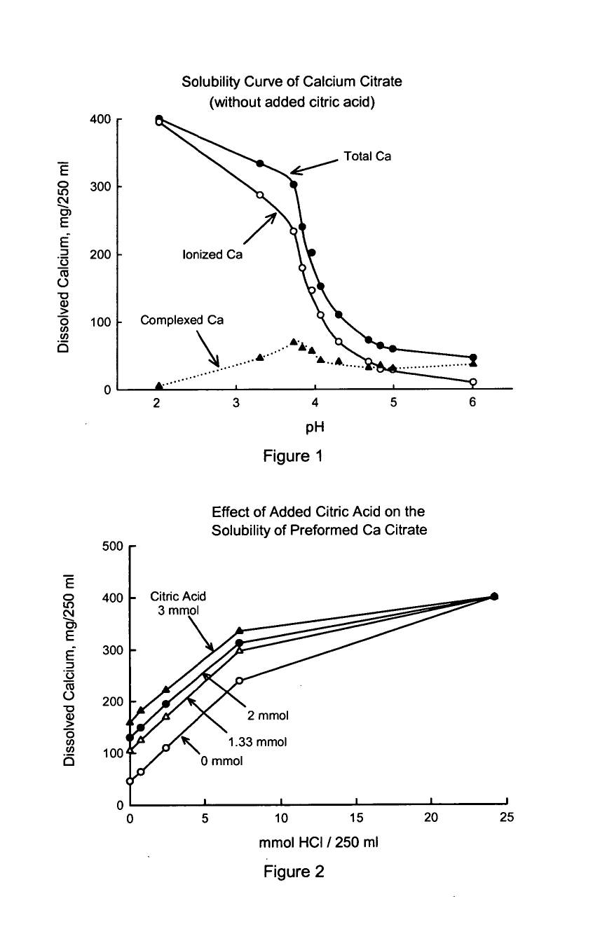

Results. From the preceding study, the amounts of total calcium, ionized calcium and complexed calcium in the filtrates are plotted against the corresponding pH (FIG. 1). For simplicity, the complexed calcium is shown as the sum of three calcium citrate complexes. At any pH, total calcium is the sum of ionized and complexed calcium. The solubility of calcium citrate, depicted by the amount of total dissolved calcium, was inversely proportional to pH, with decreasing solubility as the pH increased (became less acid). The ionized calcium curve paralleled the total calcium curve, again showing inverse dependence on pH. The amount of complexed calcium was negligible at very low pH, but clearly discernible at pH greater than 3.3 with a peak at about 3.7.

Discussion. Calcium citrate at a typical dose is nearly fully dissolved in solution containing high hydrochloric acid content, but is incompletely dissolved in less acid solutions, with only a minor fraction dissolved in the absence of any hydrochloric acid. The solubility curve of ionized calcium mirrors that of total calcium, both decreasing as the pH increases. The amount of complexed calcium, on the other hand, has an opposite trend.

### EXAMPLE 2

Enhanced solubility of preformed solid calcium citrate by adding citric acid or ascorbic acid. As is evident in FIG. 1, there are two ways of increasing the solubility of preformed calcium citrate. One way is by reducing the pH (making medium more acid) and the other way is by increasing the formation of soluble calcium complexes. Both approaches can be met by addition of certain organic acids. This Example compared the effect of citric acid and ascorbic acid, with the supposition that they would have different influences on the above two ways.

Acidification of medium by organic acids. Certain organic acids can acidify the medium of the gastric juice. The ability to do so depends on the dissociation constant of the said organic acid. The dissociation constants for various organic acids are shown in Table 1. The subscripts refer to the valence number of the said anion.

TABLE 1
Dissociation Constants of Organic Acids

| | pK₁ | pK₂ | pK₃ |
|---|---|---|---|
| Citric Acid | 3.09 | 4.75 | 5.41 |
| Lactic Acid | 3.87 | | |
| Fumaric Acid | 3.03 | 4.54 | |
| Ascorbic Acid | 4.17 | 11.57 | |

Each of above organic acids can lower pH of medium, since it can release proton as the said organic acid is dissociated to form a negatively charged anion. For an organic acid to acidify an aqueous medium, its dissociation constant should be less than the pH of the medium. In that situation, most of the said organic acid when placed in aqueous solution would become dissociated (ionized), releasing proton that lowers pH. In persons with low normal or deficient acid secretion who are a special target of calcium supplement therapy, the pH of the gastric juice ranges from 4-7, clearly within the range of pKs of organic acids listed in Table 1. In such persons then, the addition of any of above organic acid should lower the pH in the gastric juice.

At a pH range of 4-7, citric acid should be more effective than ascorbic acid in acidifying the medium. All three pKs of citric acid are in the lower half of this pH range, whereas only the first pK of ascorbic acid is. This background notes one advantage of using citric acid in enhancing the solubility of preformed calcium citrate.

Chelation of calcium by organic acids. The dissociation constants enumerated in Table 1 also affect the formation of soluble complexes of calcium and organic anions, since they determine the amount of negatively charged anions. One half of trivalent citrate anion should be available to form CaCit¹⁻ complex at pH 5.41, half of divalent anion to form CaHCit complex at pH 4.75, and half of monovalent anion to form CaH₂Cit⁺ at pH 3.09. For ascorbic acid, 50% of monovalent anion should be available at pH 4.17 to form CaHAscorb¹⁺ complex. Thus, citrate has the capacity to from three soluble complexes with calcium, whereas ascorbate forms one, at a pH range encountered in the bowel. This background is the basis of the anticipation that addition of citric acid would avidly increase the amount of soluble calcium complex but added ascorbic acid would not do so as well. It is another reason for the choice of citric acid as the preferred embodiment of this invention to increase the solubility of preformed calcium citrate.

Still another important factor that determines the propensity to form soluble calcium complexes is the stability constant. Higher the stability constant, greater is the amount of complex between the cation (ionized calcium) and anion (negatively charged). Stability constants of key soluble complexes of calcium, as gleamed from literature, are shown in Table 2. As heretofore denoted, CaCit¹⁻ is a soluble complex of calcium with trivalent citrate, CaHCit a complex of calcium with monohydrogen citrate, CaH2Cit¹⁺ a complex of calcium with dihydrogen citrate and CaHAscorb¹⁺ is a complex of calcium with monohydrogen ascorbate. Other complexes are: CaLact¹⁺ a complex of calcium and monohydrogen lactate, CaHGlucon¹⁺ a complex of calcium with monohydrogen gluconate, CaHFum¹⁺ a complex of calcium and monohydrogen fumarate, CaSuccin a complex of calcium with divalent succinate, CaHSuccin¹⁺ a complex of calcium with monohydrogen succinate, CaMal a complex of calcium and divalent malate, and CaHMal¹⁺ a complex of calcium and monohydrogen malate. The stability constant was highest for CaCit⁻, followed by CaHCit. The remaining complexes had relatively small stability constants.

TABLE 2
Stability Constants

| | Stability constant |
|---|---|
| CaCit¹⁻ | 4.78 |
| CaHCit | 2.70 |
| CaH₂Cit¹⁺ | 1.10 |
| CaHAscorb¹⁺ | 0.19 |
| CaLact¹⁺ | 0.8 |
| CaHGlucon¹⁺ | 1.22 |
| CaHFum¹⁺ | 0.48 |
| CaSuccin | 1.41 |
| CaHSuccin¹⁺ | 0.53 |
| CaMal | 2.19 |
| CaHMal¹⁺ | 1.06 |

References:
Stability Constants of Metal-Iron Complexes, Supplement No. 1, The Chemical Society, Burlington House, London, W1V OBN.
Werness et al. Equil 2: a basic computer program for the calculation of urinary saturation. J Urol 134: 1242-1244, 1985

Thus, citrate is a much more potent chelator of calcium than ascorbate, lactate, gluconate, fumarate, succinate, or malate. This background is another reason for the choice of citric acid as the preferred embodiment of this invention to increase the solubility of preformed calcium citrate.

Effect of citric acid. The same in vitro model as in prior studies with calcium carbonate was used (Pak et al., J Bone Min Res 4: 119-127, 1989). For use in the present invention, in one set of studies, 1.33 mmol of citric acid together with 400 mg (10 mmol) of calcium as preformed calcium citrate were added to 250 ml of deionized water containing 0, 0.72, 2.4, 7.26 or 24.6 mEq of hydrochloric acid. In this model system, 0 hydrochloric acid represented achlorhydria (absence of gastric acid), 0.72 mmol hydrochloric per 250 ml indicated low basal acid secretion in 1 hour, 2.4 mmmol hydrochloric acid was high basal acid secretion; 7.26 mmol hydrochloric acid was low peak acid secretion (after pentagastrin stimulation), and 24.2 mmol hydrochloric acid represented high peak acid secretion. After 1 hour of incubation at 37° C., filtrates were obtained by passing through 0.22 micron filter, and analyzed for pH, calcium, chloride and citrate. The same studies were repeated after adding 2 mmol or 3 mmol (9 milliequivalents) of citric acid.

If all of calcium citrate dissolved, the released citrate (6.67 mmol) and 1.33 mmol of added citrate gave 8 mmol of citrate, yielding calcium:citrate molar ratio of 1.25. If all of calcium citrate dissolved, calcium:citrate molar ratio was 1.15 with 2 mmol of added citric acid, and 1.03 with 3 mmol of added citric acid. In a prior study with a premix of calcium citrate (solubilized)(Pak et al., J Clin Endoc Metab 65: 801-805, 1987), calcium absorption from a premix with a molar calcium:citrate ratio of 1.25 was shown to be higher than from a premix with a ratio of 1.5 or 0.67. The ratio achieved by the addition of citric acid as embodied in this invention was the same as or close to the desired ratio of 1.25; in other words, it was optimal for absorption of calcium.

The amount of ionized and complexed calcium was calculated by the computer program Equil 2 as before. Entered into the computer program were measurements in filtrates from this model system, pH, calcium, chloride, citrate and total volume. Inserted into the software were stability constants for calcium citrate complex (CaCit¹⁻), calcium monohydrogen citrate complex (CaHCit) and calcium dihydrogen citrate complex (CaH2Cit¹⁺).

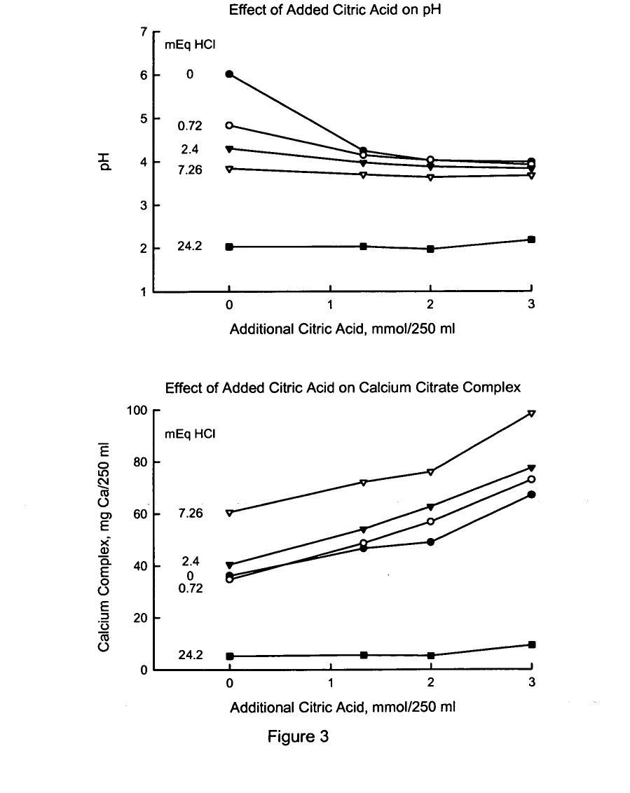

Compared to preformed calcium citrate alone, the total amount of dissolved calcium increased on addition of citric acid in all solutions, except at the highest HCl concentration (FIG. 2). Thus, calcium citrate was more soluble when citric acid was added in low to high normal states of gastric acid secretion (0-7.26 mmol hydrochloric acid per 250 ml). This action of citric acid was dose-dependent, with increasing solubility of calcium citrate as the amount of citric acid added was raised from 1.33 mmol to 3 mmol per 250 ml.

To discern how added citric acid enhances the solubility of preformed calcium citrate, its effect on pH and on the amount of complexed calcium was determined. The upper part of FIG. 3 displays the changes in pH of the medium with increasing amount of citric acid added. In solutions simulating achlorhydria to low peak acid secretion (zero to 7.26 mmol hydrochloric acid per 250 ml), the pH of the solution declined with added citric acid. The decline in pH was more pronounced in the absence or with a small amount of hydrochloric acid (associated with higher baseline pHs). In the solution containing a very large amount of hydrochloric acid (24.2 mmol per 250 ml, representative of abnormal clinical condition associated with peptic ulcer) with a very low baseline pH, there was no discernible change in pH with added citric acid.

The bottom part of FIG. 3 shows the amount of combined calcium complexes (sum of three complexes) formed with and without added citric acid. The quantity of soluble calcium citrate complexes rose with increasing amount of added citric acid in all solutions except at the highest acid content. At the highest concentration of hydrochloric acid (24.2 mmol per 250 ml), the amount of soluble complex was much less and did not change with the addition of citric acid. Thus, the addition of citric acid to preformed calcium citrate reduces pH and increases the amount of soluble complex. Both effects of added citric acid likely account for the enhancement of calcium citrate solubility observed.

Normally, some salts of calcium that are dissolved in gastric acid may precipitate out of the medium of the duodenum and upper small intestine when that fluid is neutralized by pancreatic bicarbonate secretion. This “reprecipitation” of dissolved calcium was tested in the in vitro model (Pak et al., J Bone Min Res 4: 119-127, 1989). The hypothesis tested was that the additional calcium that was dissolved by citric acid would remain dissolved when the simulated gastric juice is neutralized.

The filtrate obtained after 1 hour of incubation of preformed calcium citrate with 3 mmol citric acid in 250 ml of solution containing 2.4 mmol hydrochloric was neutralized to pH 7 by sodium bicarbonate. The volume of each filtrate was increased by 50 ml per 250 ml of filtrate to allow for the pancreatic secretion. After 30 minutes of incubation at 37° C., filtrates were refiltered through 0.22 micron filter, in order to remove any calcium salt that may have reprecipitated. The total amount of calcium in the second filtrate remained unchanged at 222 mg/day. Thus, the increased dissolved calcium produced by addition of citric acid remained in solution after simulated pancreatic bicarbonate secretion.

The concept of reprecipitation after neutralization is important in the case of calcium solubility, since it again distinguishes the action of citric acid, the preferred embodiment of this invention. Other organic anions (such as ascorbate, lactate, fumarate, gluconate, succinate, and malate) form fewer number of chelates, and/or their calcium complexes generally have lower stability constants, than citrate. Without sufficient complexation by these organic anions, the dissolved calcium may well precipitate out as calcium carbonate when the gastric acid is neutralized by bicarbonate secreted from the pancreas.

Effect of ascorbic acid. To set apart the effect of added citric acid on the solubility of calcium citrate, the effect of added ascorbic acid was tested in the same model system. Ascorbic acid has been touted to enhance the solubility of calcium salts. In 250 ml water containing varying amounts of hydrochloric acid (0, 0.72, 2.4, 7.26 and 24.2 mmol), 400 mg calcium as calcium citrate and 4.5 mmol (9 milliequivalents) of ascorbic acid were added. After 1 hour of incubation under constant stirring at 37° C., filtrates were obtained by passing through 0.22 micron filter, and analyzed for pH, calcium, chloride, citrate and ascorbate. These measures were entered onto the Equil 2 computer program in order to calculate the amount of ionized and complexed calcium.

Compared to 3 mmol (9 milliequivalents) of citric acid tested earlier, this amount of ascorbic acid had the same milliequivalents (9 milliequivalents) but higher millimolar amounts (4.5 mmol). The potential for acidification of the medium relies on the dissociation of each carboxyl group and hence on milliequivalents of the organic acid. However, the propensity for complex formation depends more on millimolar amounts of anions as the complexes are formed in equimillimolar amounts of calcium and anion. Since the expected effect of ascorbic acid was on acidification, the amount of ascorbic acid chosen for study here corresponded to equimilliequivalent amount of the highest citric acid load tested (3 mmol or 9 milliequivalents).

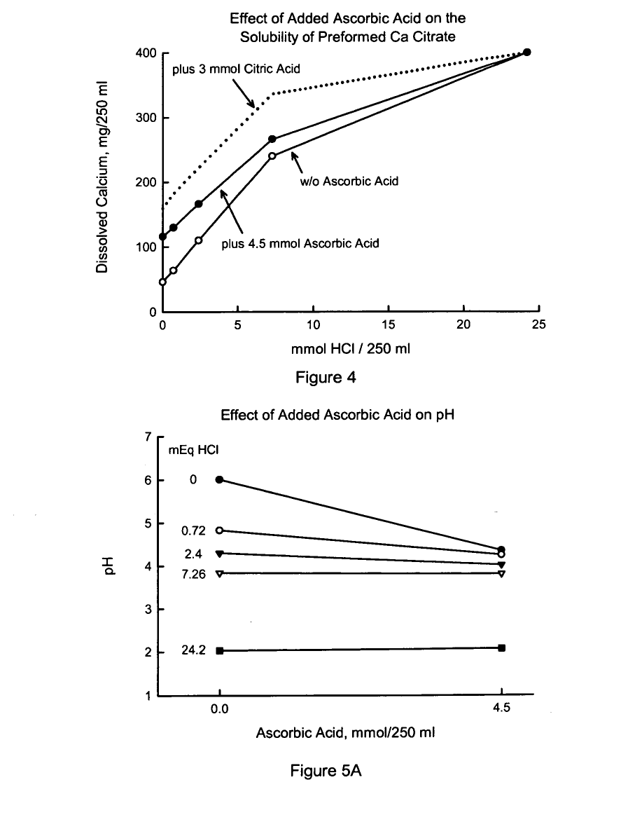

FIG. 4 reveals that the addition of ascorbic acid enhanced the solubility of calcium citrate, depicted by the total amount of dissolved calcium. This enhancement occurred in low acid solutions (zero to 2.4 mmol per 250 ml, simulated achlorhydria to high basal gastric acid secretion), but not in solutions of higher acid content (7.26 and 24.2 mmol per 250 ml, simulated low and high peak acid secretion). The rise in total dissolved calcium produced by ascorbic acid was less than that obtained with added citric acid delivering the same milliequivalents of additional organic anion (data for the same milliequivalent amounts of citric acid shown by dotted line in FIG. 4).

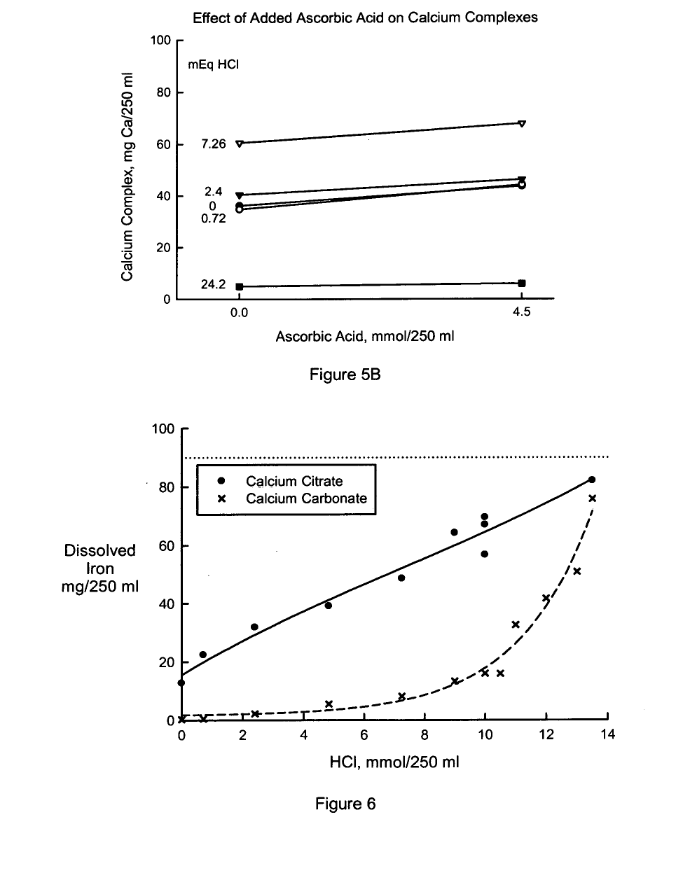

To determine how the added ascorbic acid enhances the solubility of preformed calcium citrate, the change in pH and the amount of calcium ascorbate complex was determined. The ability of ascorbic acid to decrease pH (increase acidity) depended inversely on the original hydrochloric acid content of the solution. Thus, pH declined in weak acid solutions (zero to 2.4 mmol hydrochloric acid per 250 ml) but not in solutions of higher acid content (7.26 and 24.2 mmol per 250 ml)(FIG. 5, top). Compared to the same milliequivalent amount of citric acid, the ascorbic acid was less effective in lowering pH (compare with FIG. 3 top).

The bottom of FIG. 5 shows the change in soluble calcium ascorbate complex before and after adding 4.5 mmol of ascorbic acid. Upon addition of ascorbic acid, the amount of soluble calcium complex increased slightly or not at all. Compared to added citric acid, the ascorbic acid was much less effective in increasing the complexed calcium.

Thus, the addition of ascorbic acid enhances the solubility of preformed calcium citrate mainly by increasing acidity (decreasing pH), not so much by complexing calcium. These effects of ascorbic acid are revealed in states of deficient acid secretion (0-2.4 mmol hydrochloric acid), not when gastric acid is plentiful (7.26 and 24.2 mmol per 250 ml). Compared to citric acid at the same milliequivalent amounts, ascorbic is less effective in increasing soluble calcium or lowering pH when added to preformed calcium citrate.

Conclusion. The addition of citric acid is the preferred embodiment in enhancing the solubility of preformed calcium citrate. The unique property of citric acid is due to the ability of this organic acid to acidity gastric juice and to complex calcium. Ascorbic acid is less preferred, since it acidifies but does not chelate calcium much.

The practical importance of this invention can be appreciated from this illustration. This invention teaches the addition of 288 mg of citric acid (1.5 mmol) to 951 mg of preformed calcium citrate (containing 200 mg elemental calcium, a typical content per tablet). The content of active ingredient is therefore increased by 30%. In doing so, the solubility of calcium citrate increases by 3.3-fold in achlorhydria, and by 2-fold in high basal acid secretion. If a modest goal is desired, this invention teaches adding a smaller amount of citric acid of 192 mg (1 mmol), increasing the tablet size by 20%. In so doing, the solubility of calcium citrate increases by 2.8-fold in achlorhydria, and by 1.8 fold in high basal acid secretion.

The basis of this invention is not revealed by prior art, clearly non-obvious even to one knowledgeable in the art. The past approaches employed for increasing the solubility of calcium citrate involved making a premix to be dissolved as a liquid before oral ingestion, or making a tablet formulation of calcium citrate-lactate or calcium citrate-malate that enjoys intrinsically higher solubility than calcium citrate. This invention includes a method for increasing the solubility of preformed solid calcium citrate by adding citric acid, achieved through a combined means of increasing acidity and enhancing the formation of soluble calcium citrate complexes.

The underlying premise for the present invention is that the addition of calcium citrate to carbonyl iron can keep both iron and calcium in a soluble form to be absorbed (whereas calcium carbonate cannot do so), and that the addition of citric acid can enhance the solubility of carbonyl iron. It also expects that the added calcium citrate would help to keep the iron (dissolved in gastric acid) in a soluble form and prevent it from being precipitated as the medium is neutralized by sodium bicarbonate (akin to pancreatic secretion), due in part to the release of citrate that forms soluble complexes with iron.

EXAMPLE 3

Solubility of iron and calcium from a mixture of carbonyl iron and calcium salt. Calcium salts are often combined with iron in various iron preparations, in order to provide both calcium and iron to persons who require both substances. Moreover, ascorbic acid is commonly used with carbonyl iron in order to reduce ferric to preferred ferrous iron, and for its nutritional value. As heretofore discussed, however, calcium is thought to inhibit the absorption of iron (Prather & Miller, J Nutr 122: 327-332, 1992). Moreover, some calcium salts may secondarily influence iron solubility. Calcium carbonate and calcium phosphate may cause precipitation of iron as iron carbonate and iron phosphate (Fritz et al., J AGAC 58: 902-905, 1975). Iron phosphates are just as insoluble as iron hydroxides (Aslamkhan et al., J Exp Zool 292: 507-522, 2002). Calcium carbonate also provides alkali, thereby promoting precipitation of iron hydroxides (Conrad & Schade, Gastroent 55: 35-45, 1968; McGuire et al., J Dairy Sci 68: 2621-2628, 1985).

This study was undertaken in order to test the hypothesis that calcium citrate is the preferred calcium salt when used in combination with an iron preparation to provide both iron and calcium in a soluble form. Citrate anion released from calcium citrate is a buffer with dissociation constants in the acid range. Thus, it should keep the pH of medium at a lower range than achieved by carbonate released from calcium carbonate. Moreover, the released citrate should form soluble complexes with iron (by a process called complexation or chelation), and help keep iron soluble. Another advantage of calcium citrate is its reported superior bioavailability compared to calcium carbonate (Heller et al., J Clin Pharm 40: 1237-1244, 2000) or calcium phosphate (Schuette & Knowles, Amer J Clin Nutr 47: 884-888, 1988). In this Example, calcium citrate was compared with calcium carbonate, since these calcium salts are leading calcium preparations. Calcium phosphate is rarely if ever used now, since it provides very little soluble iron (due to precipitation of iron phosphate) or soluble calcium (due to low solubility of phosphate salts of calcium).

Methods. The effect of various calcium salts on iron solubility was tested using the same in vitro model as previously described (Pak et al., J Bone Min Res 4: 119-127, 1989). Iron solubility was measured in solutions containing varying amounts of hydrochloric acid to mimic different degrees of gastric acid secretion. According to this model (to be described more fully in Example 4), zero hydrochloric acid per 250 ml represented achlorhydria (no acid secretion), 0.72 mmol per 250 ml was low basal acid secretion over 1 hour, 2.4 mmol was high basal acid secretion, 7.26 mmol was low peak acid secretion and 24.2 mmol per 250 ml was high peak acid secretion.

To test the effect of calcium citrate, 10 solutions containing varying amounts of hydrochloric acid from zero to 13.5 mmol of hydrochloric acid per 250 ml of deionized water were prepared. To each solutions, a mixture of 120 mg of ascorbic acid, 200 mg (5 mmol) calcium as tricalcium dicitrate tetrahydrate (henceforth called calcium citrate), and 90 mg iron as carbonyl iron was added. The amounts of these substances are not uncommon in a prenatal preparation. The flask containing each suspension was covered with a plastic sheet to prevent inflow of air containing oxygen. After 1 hour of incubation under stirring at 37° C., an aliquot of each suspension was filtered through a 0.22 micron filter. Filtrates were analyzed for iron, calcium, pH, chloride, ascorbate and citrate.

To test the effect of calcium carbonate, the same study was conducted, except for the replacement of calcium citrate by 200 mg calcium as calcium carbonate. Two additional samples were tested to better define curves to be described below. A pinhole was made in the plastic cover to allow escape of carbon dioxide gas. The filtrates were analyzed for iron, calcium, pH, chloride, ascorbate and bicarbonate.

Results. In the presence of calcium carbonate, iron recovery (amount of dissolved iron) increased only slightly from zero to 10.5 mmol hydrochloric acid per 250 ml (FIG. 6). Above this level of acid content, the amount of dissolved iron rapidly increased. However, in the presence of calcium citrate, iron recovery increased linearly as the hydrochloric acid content increased, from about 13 mg in the absence of acid, to 82 mg (nearly fully dissolved) at the highest hydrochloric acid concentration tested. At a corresponding level of hydrochloric acid content, the amount of dissolved iron was higher in the presence of calcium citrate than calcium carbonate. (Full iron recovery is indicated by dashed horizontal line in the Figure.)

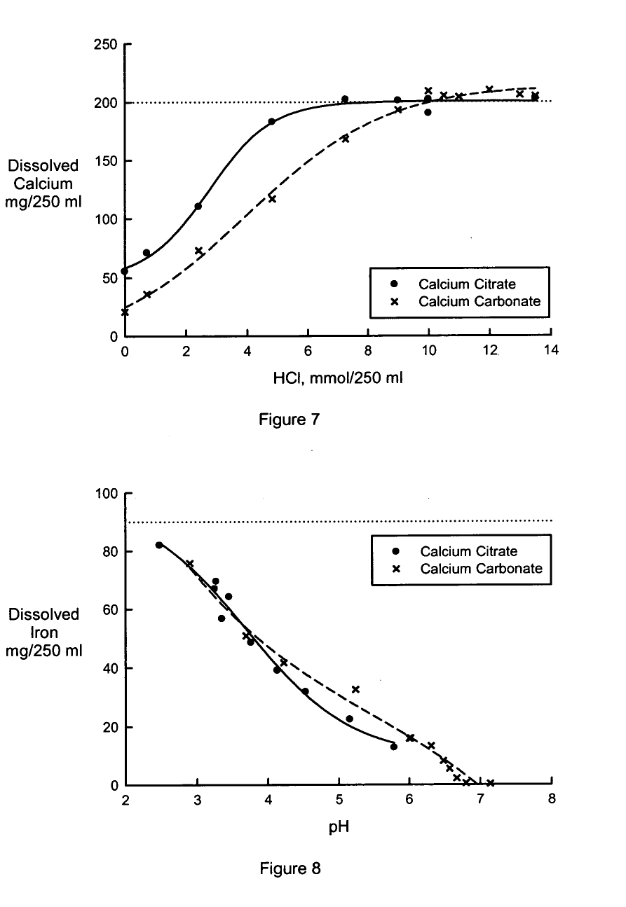

The effect adding calcium salts to iron on calcium recovery was examined by measuring dissolved calcium. The same trend was observed with calcium solubility as was observed for iron solubility (FIG. 7). Thus, the addition of calcium citrate yielded a much larger amount of dissolved calcium, than the addition of calcium carbonate. Nearly all calcium from calcium citrate was dissolved at a hydrochloric acid content of 4 mmol per 250 ml, whereas a full calcium recovery from calcium carbonate was not attained until hydrochloric acid content of 10 mmol per 250 ml. (Dashed horizontal line in the Figure depicts complete calcium recovery.)

Discussion. A seminal finding from this study is that iron is poorly dissolved in the presence of calcium carbonate in artificial solutions mimicking absent to low peak gastric acid secretion, for several reasons. Calcium carbonate is an alkali that neutralizes the acidity of the gastric juice, promoting precipitation of iron hydroxide. Carbonate released from calcium carbonate may also react with iron to form a poorly soluble ferrous carbonate.

The surprising discovery from this study is that iron is much more soluble in the presence of calcium citrate than calcium carbonate. Moreover, calcium citrate co-administered with iron yields more soluble calcium compared with calcium carbonate. These properties make a preparation of calcium citrate with carbonyl iron ideal in the management of subjects in need of both calcium and iron, such as pregnant women. Women are in need of calcium for the prevention of osteoporosis. Some of them are marginally iron deficient from menstrual blood loss and inadequate intake or absorption of iron. They may also benefit from this invention.

Both iron and calcium are included in some prenatal preparations and multivitamins. The calcium salt used commonly is calcium carbonate, which is revealed by this invention to be unsatisfactory. Calcium citrate may have been used, but nothing suggests that it was done so with an intent or prior knowledge to improve iron solubility. Available data heretofore indicated the opposite, that calcium salt would inhibit iron absorption (Prather & Miller, J Nutr 122: 327-332, 1992). Most likely, calcium citrate was used based solely on its alleged superior calcium bioavailability, with no inference whatsoever on iron solubility or bioavailability. The next Example explores how calcium citrate enhances the solubility of carbonyl iron.

EXAMPLE 4

Influence of Acidity of Medium on Iron Solubility: Effect of Calcium Salts.

The solubility of iron is known to be dependent on pH of medium, being soluble in an acid medium but virtually insoluble in alkaline medium. In seeking explanation for the results obtained in Example 3, one way for calcium citrate to produce a higher solubility of iron is by preventing the rise in pH (alkalinization) that occurs with calcium carbonate.

Gastric juice is normally acid, due to the secretion of hydrochloric acid by the stomach. Different degrees of gastric acid secretion have been previously defined (Pak et al., J Bone Miner Res 4: 119-127, 1989). A total absence of acid secretion is a disease state called achlorhydria. A normal postmenopausal woman under basal conditions secretes between 0.72 mmol hydrochloric acid per hour to 2.4 mmol per hour. After pentagastrin stimulation, 7.26 to 24.2 mmol of hydrochloric acid are secreted per hour. Assuming the volume of gastric juice to be 250 ml and the reaction time of iron with gastric juice to be 1 hour, a model laboratory system for studying solubility of oral mineral supplements in a simulated gastric juice was developed (Pak et al., J Bone Miner Res 4: 119-127, 1989), wherein 250 ml water containing 0 hydrochloric acid was achlorhydria, 0.72 mmol low basal acid secretion, 2.4 mmol high basal acid secretion, 7.26 mmol low peak acid secretion, and 24.2 mmol hydrochloric acid was high peak acid secretion (analogous to a clinical condition called Zollinger-Ellison syndrome with intractable ulcer disease). By this definition, 10 mmol hydrochloric acid per hour would indicate a slightly higher rate than low peak acid secretion.

Except in achlorhydria and low basal acid secretion, the amount of hydrochloric acid secreted (2.4 to 24.2 mmol per hour) should be sufficient to react with iron given as an oral preparation (usually 90 mg or less per tablet) to form soluble iron chloride. As previously discussed, past studies have suggested that iron chloride is soluble in moderately acid medium, but is converted to insoluble iron salt in less acid medium (Barton et al., Gastroenter 84: 90-101, 1984; Conrad & Schade, Gastroenter 55: 35-45, 1968). The precipitated iron salt formed is either ferrous hydroxide or ferric hydroxide depending on whether the conditions favored the presence of ferrous or ferric iron. The ferric hydroxide is less soluble than ferrous hydroxide (Aslamkhan et al., J Exp Zool 292: 507-522, 2002).

The published reports on the solubility curves of iron over varying pH is conflicting, in part due to different concentrations of iron employed, varying forms of iron chloride used, and inter-conversion between ferric and ferrous cations. When a physiological concentration of ferrous chloride (1 mmol per liter) was used, the critical pH when the iron solubility declined was 4 (Barton et al., Gastroenter 84: 90-101, 1984). When an abnormally high concentration of ferrous chloride (100 mmol or 5.6 g iron per liter) was employed, the precipitation of iron occurred at a much higher pH (Conrad & Schade, Gastroenter 55: 35-45, 1968). Using a very high concentration of ferric chloride, the precipitation of iron occurred at about pH 3-4. Regardless of the exact nature of the solubility curves of iron, it is clear that iron solubility decreases with increasing pH due to precipitation of iron hydroxides, and that very little iron is available in a soluble form in a slightly acid or neutral medium (as in the medium of the duodenum and upper jejunum where iron absorption takes place). The objective of this Example was to construct the solubility curve of iron for a typical iron-calcium preparation in simulated gastric juices at body temperature.

Methods and Results. From results obtained in Example 3, the dissolved iron was plotted against the pH in FIG. 8. The iron solubility curve of calcium citrate (solid curve) was nearly indistinguishable from that of calcium carbonate (dashed curve). The dissolved iron decreased progressively from nearly full recovery at pH 2-3 to virtually no recovery at pH of about 7. Thus, iron was more soluble in more acid solutions (lower pH). (The dashed horizontal line indicates full iron recovery.)

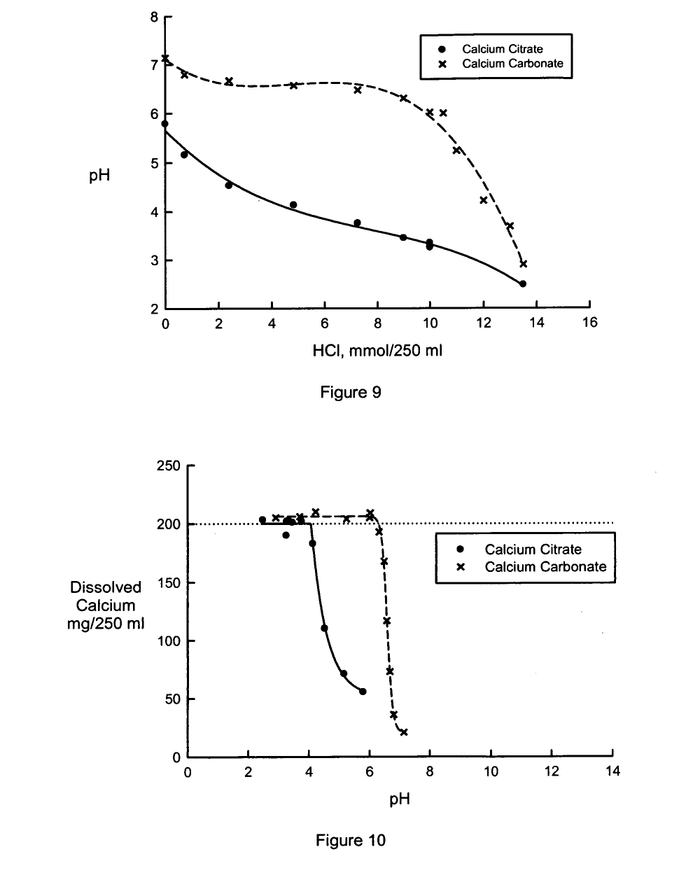

In FIG. 9, the pH of solution is plotted against the corresponding hydrochloric acid content. The pH declined with increasing hydrochloric acid content with both calcium salts. However, at a corresponding level of hydrochloric acid content, pH was lower in the presence of calcium citrate than calcium carbonate.

In FIG. 10, calcium solubility (dissolved calcium) is plotted against pH. Calcium citrate was fully dissolved at pH less than pH 4. Dissolved calcium rapidly fell as the pH increased above pH 4. Calcium carbonate was fully dissolved at pH less than 6. Dissolved calcium rapidly declined as the pH increased above 6.

From the data derived from the study above, the amount of complexed iron in filtrates was calculated by the modified computer program Equil 2 that was designed for estimating the urinary saturation of stone-forming salts (Werness et al., J Urol 134:1242-1244, 1985). Entered into the computer program were values for iron, pH, calcium, chloride, ascorbate, citrate, and bicarbonate in the filtrates. For this study, the stability constants for ferric citrate (FeCit), ferric monohydrogen citrate (FeHCit⁺), ferrous citrate (FeCit⁻), ferrous monohydrogen citrate (FeHCit), as well as ferrous monohydrogen ascorbate (FeHAscorb¹⁺), calcium citrate (CaCit¹⁻), calcium dihydrogen citrate (CaH₂Cit¹⁺), and calcium monohydrogen citrate (CaHCit) were inserted into the software program. The total complexed iron represented the sum of the five iron complexes. The theory and method for the calculation of soluble complexes will be discussed more fully in Example 4.

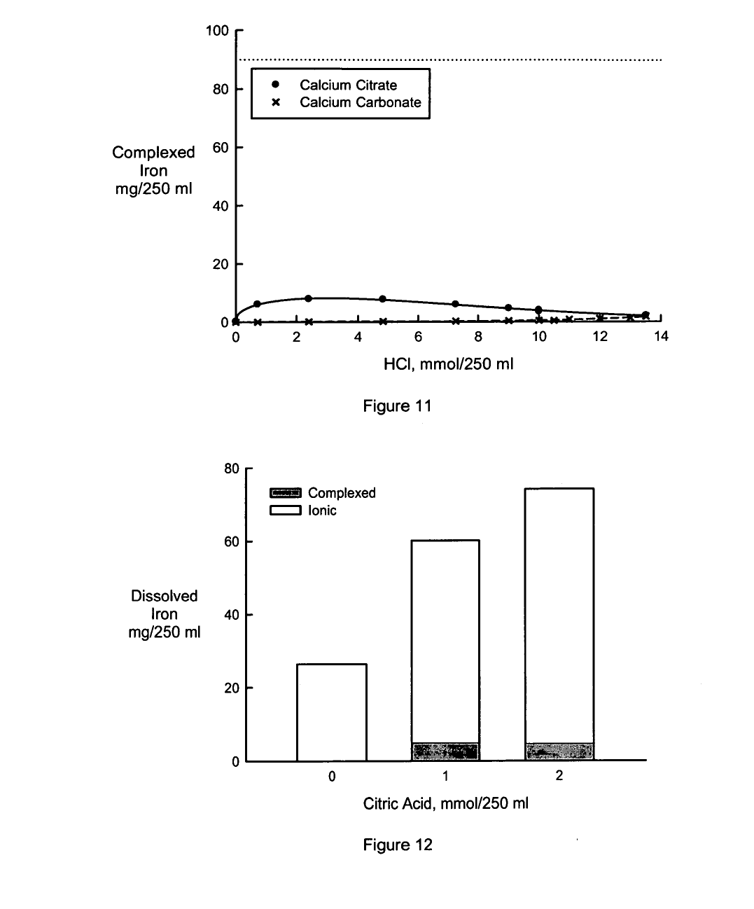

In FIG. 11, the total amount of complexed iron was calculated and shown for varying amounts of hydrochloric acid. The amount of complexed iron in the presence of calcium citrate was small compared with full iron recovery (shown by dashed horizontal line), and did not vary much with increasing acid content. In the presence of calcium carbonate, the amount of complexed iron was negligible. A very small but discernible amount of complexed iron displayed at higher pHs was due to iron ascorbate complex.

Discussion. The iron solubility is inversely dependent on pH. Thus, one way the co-administered calcium salt can increase the solubility of carbonyl iron is by increasing acidity (or decreasing pH). At the same level of hydrochloric acid content of solution, calcium citrate yields lower pH than calcium carbonate. Thus, calcium citrate yields higher iron solubility than calcium carbonate by keeping medium more acid.

The higher acidity of the medium in the presence of calcium citrate than calcium carbonate can be explained by different dissociation constants (pKs) for citrate and bicarbonate anions. When calcium citrate dissolves, it releases citrate anion. Citrate anion has pKs of 3.09, 4.75, and 5.41, corresponding to three anionic groups. Thus, at a pH greater than 3.09, more than 50% of monovalent citrate should be dissociated as H₂Cit¹⁻. At a pH greater than 4.75, more than 50% of divalent citrate should be dissociated as HCit²⁻. At a pH greater than 5.41, more than 50% of trivalent citrate should be dissociated as Cit³⁻. Citrate serves as a buffer. When the pH of the medium is higher than the pKs, citrate can acidify the medium. When the pH of the medium is lower than the pKs, citrate can make the medium less acid. The above properties make calcium citrate an acidifying agent in neutral or weak acid solutions, and an alkalinizing agent in more acid solutions. When calcium carbonate dissolves, it releases carbonate and bicarbonate anions. Carbonate anion has pKs of 6.1 and 10.3. Thus, in acid medium of the stomach, calcium carbonate is an alkalinizing agent.

The calcium solubility curves shown in FIG. 10 support the above conclusion. Here, calcium served as a “titrant”. The rapid decline in the amount of dissolved calcium occurred at pH of about 4 for calcium citrate, corresponding to pKs of citrate of 3.09-5.41. The rapid decline in dissolved calcium occurred at pH of about 6, corresponding to pK₁ of 6.1.

The formation of soluble iron complexes can theoretically increase the apparent solubility of iron. However, the amount of complexed iron was small and did not change with increasing hydrochloric acid content. Thus, when a mixture of carbonyl iron, ascorbic acid and a calcium salt is suspended in an aqueous medium, the solubility of iron was determined largely by acidity of the medium, not much by soluble complex formation.

Conclusion. The superior ability of calcium citrate in enhancing iron solubility is largely the result of its acidifying action, as opposed to alkalinizing action of calcium carbonate. The complexation of iron by citrate has a minimal effect on increasing the solubility of iron de novo.

EXAMPLE 5

Enhanced Solubility of Iron by Adding Citric Acid to Carbonyl Iron in Simulated Low Basal Acid Secretion.

Iron solubility and absorption are known to be poor among patients with defective gastric acid secretion. The enhancement of iron solubility should therefore be particularly useful in such patients. In this Study, the effect of added citric acid on the solubility of carbonyl ion was tested in simulated low basal acid secretion. So as to be applicable clinically, a common composition of prenatal preparations was employed, containing 90 mg carbonyl iron and 120 mg ascorbic acid per tablet (but no calcium).

Methods. The same in vitro model was employed (Pak et al., J Bone Min Res 4: 119-127, 1989). Three solutions containing 0.72 mmol of hydrochloric acid per 250 ml (mimicking low basal gastric acid secretion) were prepared. To each solution, 90 mg (1.62 mmol) of iron as carbonyl iron were added. Citric acid in varying amounts (0, 1, and 2 mmol) was added to the solutions. After 1 hour of incubation at 37° C., filtrates were obtained and analyzed for iron, pH, chloride, ascorbate and citrate. Data were entered onto the Equil 2 program for the calculation of iron complexes.

Results. FIG. 12 shows the total dissolved iron (combined clear and shaded areas of the blocks), free iron (clear portion of the blocks) and complexed iron (shaded portion of blocks). The total and free iron substantially increased when citric acid was added to carbonyl iron. This effect was dose-dependent, with a greater amount of total and free iron recovered when a larger amount of citric acid was added.

In the absence of any citric acid, there was no soluble iron complex. Since ascorbic acid had been present, the finding suggested that little if any iron ascorbate complex is formed. In the presence of added citric acid, some iron complex formed (shown by shaded portion of blocks in FIG. 12), but the amount of complex represented only a small fraction of total dissolved iron. Thus, the addition of citric acid to carbonyl iron did not substantially alter the amount of complexed iron.

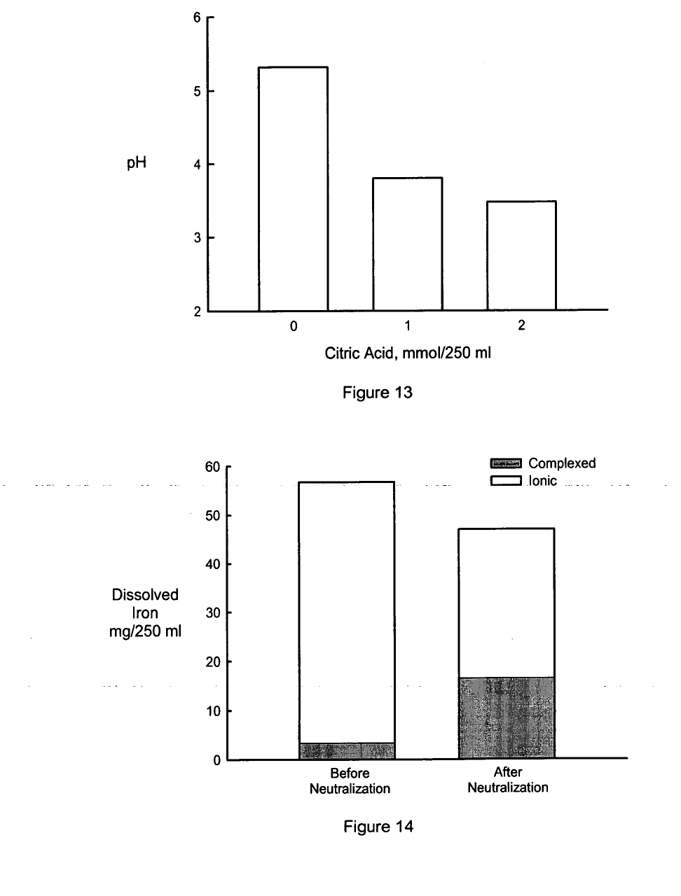

The pH of the medium decreased with the addition of citric acid (FIG. 13). The pH declined from 5.32 in the absence of citric acid, to 3.47 with 2 mmol of added citric acid.

Discussion. In the setting of deficient gastric acid secretion, the addition of citric acid substantially increases the amount of soluble iron in a dose dependent manner, owing to acidification of medium from 5.32 to 3.47. In this pH range of the medium, very little soluble iron citrate complexes form. Thus, the added citric acid enhances the solubility of carbonyl iron principally by acidifying the medium.

In most situations, it may be more useful to add calcium citrate rather than citric acid to enhance the solubility of carbonyl iron. The added calcium citrate affords soluble iron as well as calcium, whereas added citric acid yields only soluble iron. However, the method of adding citric acid should be useful in making a sole iron preparation more soluble and bioavailable, particularly in persons with deficient gastric acid secretion.

### EXAMPLE 6

Retardation of “Reprecipitation” of Dissolved Iron by Formation of Soluble Iron Citrate Complexes, Following Neutralization of Acid Medium with Sodium Bicarbonate.

Gastric fluid is generally acid due to secretion of hydrochloric acid. On the other hand, the luminal fluid of the duodenum and upper small bowel is slightly acid to neutral due to sodium bicarbonate secretion from the pancreas. As shown before, iron solubility is dependent on the acidity of the medium. Thus, iron that is dissolved in the acid gastric fluid is normally re-precipitated as iron hydroxide in the slightly acid-neutral fluid of the duodenum and upper small bowel. This study was conducted in order to determine if the presence of citrate anion may retard this re-precipitation by forming soluble iron complexes.

Methods. From Example 3, the study conditions of dissolution of carbonyl iron in the presence of calcium citrate in a solution containing 10 mmol hydrochloric acid per 250 ml, were chosen for this study. As revealed in FIG. 6, a substantial amount of iron (57-70 mg per 250 ml) was dissolved in the presence of calcium citrate, ideal to test the effect of re-precipitation. On the other hand, a much smaller amount (16 mg) was dissolved in the presence of calcium carbonate, excluding the need to test re-precipitation.

To 250 ml of deionized water containing 10 mmol of hydrochloric acid, a mixture of 90 mg iron as carbonyl iron, 120 mg ascorbic acid, and 200 mg calcium as calcium citrate was added. After incubation under constant stirring at 37° C., the suspension was filtered through 0.22 micron filter. To 125 ml of filtrate (one/half of original volume) kept under constant stirring at 37° C., 25 ml of 0.2 N sodium bicarbonate (5 mmol, equivalent to 10 mmol for a full volume) was added by a minipump at a constant speed over 30 minutes, designed to simulate pancreatic secretion. The final volume was 150 ml (1.2-fold dilution). The filtrate was again obtained, and analyzed for iron, pH, chloride, citrate, ascorbate, bicarbonate, sodium and calcium. From the analyzed values, iron complexes were calculated by the Equil 2 program. As before, the total amount of soluble complexed iron represented the sum of FeCit, FeHCit¹⁺, FeCit¹⁻, FeHCit, and FeHAscorb¹⁺.

FIG. 14 reveals the total amount of dissolved iron before (left side of the Figure) and after (right side) neutralization with sodium bicarbonate. The total amount of dissolved iron is the sum of free (open area) and soluble complexed iron (shaded area). Just before neutralization following incubation of carbonyl iron with calcium citrate in 250 ml water containing 10 mmol of hydrochloric acid, the total dissolved iron was 56.7 mg and pH was 3.35. After titration with sodium bicarbonate, the pH increased to 7.09. The amount of dissolved iron (corrected for volume) was 47.0 mg, representing only a 17% decrease from 56.7 mg. Note that the amount of soluble iron was negligible in the presence of calcium carbonate at neutral pH (FIG. 8).

FIG. 14 also shows the total amount of complexed iron before and after neutralization. The amount of complexed iron (shown by shaded area) was negligible at pH 3.35 before neutralization (left of Figure). At pH 7.09 after neutralization, the amount of complexed was substantial, representing about 40% total dissolved iron.

Discussion. Normally, the iron that is dissolved in gastric acid becomes unavailable for absorption in the duodenum and upper small bowel, because it is largely precipitated as iron hydroxide (due to pancreatic bicarbonate secretion). This invention makes a claim that the addition of calcium citrate to iron largely overcomes this problem, partly by releasing citrate that forms soluble complexes with iron.

Ability of citrate to form soluble complexes with iron. Without being bound by theory, the complexation of iron in the presence of citrate will now be reviewed, in order to better understand the embodiment of this invention. Iron cations (positively charged, divalent ferrous and trivalent ferric ions) form soluble complexes with certain anions (negatively charged ions). When iron is suspended in water containing hydrochloric acid and said anion, the ambient phase (filtrate) is comprised of iron cation (ferrous or ferric), soluble iron-anion complexes, and the accompanying chloride and anions, all of which are in equilibrium with the remaining solid phase (non-dissolved iron hydroxide). The soluble iron is therefore comprised of free ion and iron-anion complexes. Thus, a maneuver to prevent or retard the re-precipitation of iron upon neutralization by pancreatic bicarbonate secretion is to encourage the formation of soluble complexes of iron. One such maneuver is adding calcium citrate to an iron preparation.

When calcium citrate is dissolved in water, it releases three citrate groups, included monovalent, divalent and trivalent species. Two species of citrate anion can complex iron. In contrast, carbonate released from the dissolution of calcium carbonate does result in iron complexes.

There are two necessary conditions for the formation of soluble iron complexes,-desirable dissociation constants and stability constants. First, the dissociation constant or pK determines how much of the said organic acid anion is dissociated to form anion (negatively charged ion) that can react with iron cation. If the pH is equal to pK, 50% of anion is dissociated. If the pH is less than pK, there is insufficient amount of anion in a dissociated form. The pH must therefore be greater than pK, in order to allow for optimum complexation to take place.

Citrate released from calcium citrate has 3 pKs of 3.09, 4.75, and 5.41, corresponding to three anionic groups as previously discussed. Thus, at a pH greater than 4.75, 50% of divalent citrate should be dissociated as HCit²⁻ to react with ferric cation (Fe⁺³) to form FeHCit¹⁺, and with ferrous cation (Fe²⁺) to form FeHCit. At a pH greater than 5.41, more than 50% of trivalent citrate should be dissociated as Cit³⁻ to react with ferric cation to form FeCit, and with ferrous cation to form FeCit¹⁻. In other words, two citrate complexes of iron can optimally develop at a pH greater than 4.75, and all four citrate complexes of iron can optimally form at a pH greater than 5.41. Thus, in slightly acid to neutral medium of the duodenum and upper small bowel where iron is absorbed (Barton et al., Gastroenter 84: 90-101, 1983), the conditions are favorable for the formation of soluble iron citrate complexes.

An equally important factor that determines the propensity to form a soluble complex is the stability constant. The stability constant provides a measure of the propensity for soluble complex formation. Higher the stability constant, greater is the amount of complex between cation (such as ferrous or ferric ion) and given anion. The known stability constants of soluble complexes relevant to this invention are shown in Table 3.

TABLE 3
The Stability Constants of Soluble Iron Complexes

| | Stability |
|---|---|
| | constant |
| Ferric citrate (FeCit) | 12.50 |
| Ferric monohydrogen citrate (FeHCit¹⁺) | 6.31 |
| Ferrous citrate (FeCit¹⁻) | 3.08 |
| Ferrous monohydrogen citrate (FeHCit) | 2.12 |
| Aluminum citrate | 4.93 |
| Calcium citrate (CaCit¹⁻) | 4.78 |
| Ferrous monohydrogen ascorbate (FeHAscorb¹⁺) | 1.30 |

References:
Stability Constants of Metal-Iron Complexes, Supplement No. 1, The Chemical Society, Burlington House, London, W1V OBN.
Plug et al. Complex stability of ferrous ascorbate in aqueous solutions and its significance in iron absorption. Pharm Weekbl Sci 6: 245-248, 1984.

The stability constants of ferric cation with citrate are higher than those of ferrous cation with citrate. The stability constants of aluminum citrate complex (AlCit) and calcium citrate complex (CaCit¹⁻) are provided in Table 3 as a reference. The formation of AlCit complex is believed to cause excessive absorption of aluminum from the bowel causing aluminum toxicity among patients with chronic kidney disease ingesting aluminum-containing medications with citrus fruit juices (Slanina et al., 32: 339-341, 1986). The formation of CaCit¹⁻ has been implicated to partly explain superior absorption of calcium citrate over other calcium salts among persons with estrogen lack or marginal vitamin D deficiency who may lack the ability to absorb calcium by an active transport process (requiring energy)(Heller et al., J Clin Pharm 42: 1251-1256, 2002). Both complexes are known or believed to be absorbed passively, that is, without expenditure of energy (Slanina et al., 32: 339-341, 1986; Favus & Pak, Amer J Therap 8: 425-431, 2001).

Compared to these clinically meaningful citrate complexes of aluminum and calcium, the stability constants for ferric citrate complexes are higher, and those of ferrous citrate complexes are slightly lower. Thus, the tendency for the formation of ferric citrate complexes is considerable greater, and that of ferrous citrate complexes somewhat lower, compared with the aluminum citrate complex or the calcium citrate complex. The foregoing discussion denotes the likelihood of formation and clinical importance of the citrate complexes of iron.

On the other hand, the stability constant of iron ascorbate complex is lower than that of any iron citrate complexes, and much lower than that of aluminum or calcium citrate complexes (Table 1). Thus, the clinical relevance of ascorbic acid in enhancing the solubility of iron through soluble complex formation is uncertain under physiological conditions (Plug et al., Pharmaceutisch Weekblad Scient Ed 6: 245-248, 1984). The purpose of adding ascorbic acid to an iron preparation in the Studies described in this invention was to ensure reduction of ferric to ferrous cation, and to conform to the common composition of prenatal preparations.

Conclusion. Citrate released from calcium citrate helps to keep iron in a soluble state, preventing re-precipitation of iron when acid gastric fluid is neutralized by sodium bicarbonate secreted from pancreas.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Aslamkhan A G, Aslamkhan A, Ahearn G A. Preparation of metal ion buffers for biological experimentation: a methods approach with emphasis on iron and zinc. J Exp Zool 292: 507-522, 2002.

Barton J C, Conrad M E, Parmley R T. Calcium inhibition of inorganic iron absorption in rats. Gastroenter 84: 90-101, 1983.

Conrad M E, Schade S G. Ascorbic acid chelates in iron absorption: a role for hydrochloric acid and bile. Gastroenter 55: 35-45, 1968.

Favus M J, Pak CYC. Evidence for absorption of ionic calcium and soluble calcium complexes by the duodenum and cecum in the rat. A m J Therapeut 8: 425-431, 2001.

Fritz J C, Pla G W, Harrison B A, Clark G A. Vitamins and other nutrients: estimation of the bioavailability of iron. J AOAC 58: 902-905, 1975.

Graham R M, Morgan E H, Baker E. Characterization of citrate and iron citrate uptake by cultured rat hepatocytes. J Hepatol 29: 603-613, 1998.

Heller H, Greer L G, Haynes S, Poindexter J, Pak CYC. Pharmacokinetic and pharmacodynamic comparison of two calcium supplements in postmenopausal women. J Clin Pharm 40: 1237-1244, 2000.

Heller H J, Poindexter J R, Adams-Huet, B. Effect of estrogen treatment and vitamin D status on differing bioavailabilities of calcium carbonate and calcium citrate. J Clin Pharm 42: 1251-1256, 2002.

McGuire S O, Miller W J, Gentry R P, Neathery M W, Ho SY, Blackmon D M. Influence of high dietary iron as ferrous carbonate and ferrous sulfate on iron metabolism in young calves. J Dairy Sci 68: 2621-2628, 1985.

O'Connell M B, Madden D M, Murray A M, Heaney R P, Kerzner L J. Effects of proton pump inhibitors on calcium carbonate absorption in women: a randomized crossover trial. Amer J Med 118: 778-781.

Pak CYC, Harvey J A, Hsu M C. Enhanced calcium bioavailability from a solubilized form of calcium citrate. J Clin Endoc Metab 65: 801-805, 1987.

Pak CYC, Poindexter C, Finlayson B. A model system for assessing physicochemical factors affecting calcium absorbability from the intestinal tract. J Bone Min Res 4: 119-127, 1989.

Plug C M, Dekker D, Bult A. Complex stability of ferrous ascorbate in aqueous solution and its significance for iron absorption. Pharm Weekbl Sci Edit 6: 245-248, 1984.

Prather T A, Miller D D. Calcium carbonate depresses iron bioavailability in rats more than calcium sulfate or sodium carbonate. J Nutr 122: 327-332, 1992.

Schuette S A, Knowles J B. A comparison of intestinal absorption of Ca(H₂PO₄)₂ and Ca citrate by two methods. Amer J Clin Nutr 47: 884-888, 1988.

Slanina P, Frech W, Ekstrom L-G, Loof L, Slorach S, Cedergren A. Dietary citric acid enhances absorption of aluminum in antacids. Clin Chem 32: 539-541, 1986.

Werness P G, Brown C M, Smith L H, Finlayson. EQUIL 2: a basic computer program for the calculation of urinary saturation. J Urol 134: 1242-1244, 1985.

Zhang D, Hendricks D G, Mahoney A W. Bioavailability of total iron from meat, spinach (Spinacea oleracea L) and meat-spinach mixtures by anaemic and non-anaemic rats. Brit J Nutr 61: 331-343, 1989.

U.S. Pat. No. 4,722,847. Fruit juice beverages and juice concentrates nutritionally supplemented with calcium. Inventor: David C. Heckert.

U.S. Pat. No. 4,851,221. Liquid calcium supplementation from readily soluble mixtures of calcium compound and citric acid. Inventors: Charles Y. C. Pak and Neill B. Walsdorf.

U.S. Pat. No. 5,075,499. Calcium supplementation by dicalcium citrate-lactate. Inventors: Neill B. Walsdorf, George Alexandrides and Charles Y. C. Pak.

What is claimed is:

1. A method of enhancing calcium bioavailability of a calcium citrate-containing tablet by a proportionately greater amount relative to change in weight under physiological conditions, comprising:
preparing solid preformed calcium citrate;
adding citric acid to the calcium citrate, wherein citric acid is added to the calcium citrate in a molar ratio of between 0.1 and 0.6 mol of citric acid per mol of calcium citrate to provide a calcium citrate-citric acid mixture; and
forming a tablet from the calcium citrate-citric acid mixture.

2. The method of claim 1, wherein the molar ratio between citric acid per mol of calcium citrate is between 0.133 and 0.3.

3. The method of claim 1, further comprising carbonyl iron.

4. The method of claim 1, where the amount of calcium citrate is 50-350 mg calcium per tablet.

5. The method of claim 1, where the amount of calcium citrate is 200-315 mg calcium per tablet. The method of claim 1, wherein the citric acid is anhydrous or a monohydrate.

6. The method of claim 1, wherein tablet further comprises an enteric coating.

7. The method of claim 1, wherein tablet is a dual-layer tablet comprising an immediate release and a sustained release portion.

8. The method of claim 1, wherein tablet delivers 50-350 mg calcium as preformed calcium citrate tablet with less than 80% the tablet volume.

9. The method of claim 1, wherein tablet is compressed to a bulk density of between 0.9 g/cc and 1.3 g/cc.

10. The method of claim 1, wherein tablet further comprises one or more vitamins selected from the group consisting of vitamin A, vitamin B1, vitamin B2, vitamin B6, vitamin B12, vitamin C, vitamin D, vitamin E, folic acid, iodine, copper, zinc, niacinamide, and any combination thereof.

11. A method of controlling tablet size of a calcium citrate-containing tablet for human consumption, while enhancing bioavailability of calcium when in the human digestive system, comprising:
preparing solid preformed calcium citrate;
adding citric acid to the calcium citrate, wherein citric acid is added to the calcium citrate in a mol ratio of between 0.1 and 0.6 mol of citric acid per mol of calcium citrate to provide a calcium citrate-citric acid mixture; and
forming a tablet from the calcium citrate-citric acid mixture.

12. A method of making a calcium citrate-and-iron containing tablet for human consumption, with enhanced bioavailability of calcium and iron when in the human digestive system comprising:
preparing a blend of calcium citrate and carbonyl iron, wherein the molar ratio of carbonyl iron to calcium citrate is between 0.04 and 1.5;
adding citric acid to the calcium citrate, wherein citric acid is added in total of a molar ratio of between 0.1 and 0.6 mol of citric acid per mol of calcium citrate plus a molar ratio of between 0.1 and 3.0 mol of citric acid per mol of carbonyl iron to provide a calcium citrate-carbonyl iron-citric acid combination; and
forming a tablet from the calcium citrate-carbonyl iron-citric acid combination, whereby when consumed by a human, solubility of iron and calcium citrate are enhanced.

13. The method of claim 12, wherein the molar ratio of citric acid per mol of carbonyl iron is at or between 0.62 and 1.23.

14. The method of claim 12, wherein the molar ratio of carbonyl iron to calcium citrate is 0.32.

15. A method of making an iron-containing tablet for human consumption, with enhanced bioavailability of calcium and iron when in the human digestive system comprising:
preparing a predetermined amount of carbonyl iron;
adding citric acid to the carbonyl iron, wherein citric acid is added in a molar ratio of between 0.1 and 3 mol of citric acid per mol of carbonyl iron to provide a carbonyl iron-citric acid combination; and
forming a tablet from the carbonyl iron-citric acid combination, whereby when consumed by a human, solubility of iron is enhanced.

16. A tablet made by a method comprising:
preparing solid preformed calcium citrate;
adding citric acid to the calcium citrate, wherein citric acid is added to the calcium citrate in a molar ratio of between 0.1 and 0.6 mol of citric acid per mol of calcium citrate to provide a calcium citrate-citric acid mixture; and
forming a tablet from the calcium citrate-citric acid mixture.

17. A method of treating a vitamin or mineral deficiency of a mammal, the method comprising the step of administering a formulation comprising:
a solid preformed source of calcium citrate; and
an organic acid in a molar ratio of between 0.1 and 0.6 mol of citric acid per mol of calcium citrate to provide a calcium citrate-citric acid mixture.

18. The method of claim 17, wherein the organic acid comprises citric acid.

19. The method of claim 17, wherein the organic acid comprises lactic acid, fumaric acid, succinic acid, malic acid, ascorbic acid and combinations thereof.

20. The method of claim 17, wherein the source of calcium citrate comprises ultradense calcium citrate, calcium lactate, calcium fumarate, calcium succinate, calcium malate, calcium ascorbate, calcium acetate or calcium gluconate, calcium citrate-lactate, calcium citrate-malate, and combinations thereof.

21. The method of claim 17, wherein the calcium citrate is 50-350 mg (1.25-8.75 mmol) calcium per tablet.

22. The method of claim 17, wherein the molar ratio of citric acid to calcium citrate is between 0.1 and 0.6 mol of citric acid per mol of calcium citrate.

23. The method of claim 17, wherein the formulation further comprises a source of iron.

24. The method of claim 23, wherein the human is a pregnant women and postmenopausal women with borderline iron deficiency, osteoporosis, osteomalacia/rickets, low blood calcium, achlorhydria or an induced deficiency in gastric acid production.

25. The method of claim 23, wherein the amount of iron per dose ranges from 0.2 mmol to 3 mmol (11-168 mg) and that of citric acid from 0.5 mmol to 4 mmol (94-756 mg).

26. The method of claim 23, wherein the iron comprises a carbonyl iron, an insoluble iron (reduced iron, iron oxide, iron carbonate or iron succinate), a soluble iron (iron lactate, iron fumarate, iron malate, iron ascorbate, or iron gluconate) and combinations thereof.

27. A method of reducing size of a calcium-citrate-containing tablet for human consumption, without reducing bioavailability of calcium from the tablet when in the human digestive system, comprising:
preparing solid preformed calcium citrate;
adding citric acid to said calcium citrate, wherein citric acid is added to said calcium citrate in a ratio of between 1.33 and 2 mmol of citric acid per 10 mmol of calcium as preformed calcium citrate to provide a calcium citrate-citric acid mixture; and
forming a tablet from said calcium citrate-citric acid mixture, whereby when consumed by a human, the added citric acid not only maintains more calcium in soluble form, especially in portions of the human digestive system that are slightly acidic, but also improves the solubility of calcium citrate in digestive systems of humans with low normal or low acid content, and whereby adding a limited amount of citric acid provides significantly enhanced bioavailability of calcium in the human digestive system can be attained for a given tablet size or an even greater bioavailability of calcium with only a relative small increase in tablet size.

28. A method of enhancing calcium bioavailability of a calcium citrate-containing tablet by a proportionately greater amount relative to change in weight under physiological conditions, comprising:
preparing solid preformed calcium citrate;
adding citric acid to the calcium citrate, wherein citric acid is added to the calcium citrate in a molar ratio of between 1.33 and 3 mol of citric acid per 10 mol of calcium citrate to provide a calcium citrate-citric acid mixture; and
forming a tablet from the calcium citrate-citric acid mixture.
